(19) United States
(12) Patent Application Publication
(10) Pub. No.: US 2020/0248914 A1
(43) Pub. Date: Aug. 6, 2020

(54) PRINTED CIRCUIT BOARD OF AN HVAC CONTROLLER

(71) Applicant: Johnson Controls Technology Company, Auburn Hills, MI (US)

(72) Inventors: Joshua J. Yagy, St. Petersburg, FL (US); Timothy J. Wilson, St. Petersburg, FL (US); James A. Cavanaugh, Tampa, FL (US)

(21) Appl. No.: 16/288,936

(22) Filed: Feb. 28, 2019

Related U.S. Application Data
(60) Provisional application No. 62/799,737, filed on Jan. 31, 2019.

(51) Int. Cl. F24F 11/30; F24F 11/56; H01F 27/06

(52) U.S. Cl. CPC F24F 11/30; H01F 2027/065; H01F 27/06; F24F 11/56

(57) ABSTRACT

A controller of a heating, ventilation, and/or air conditioning (HVAC) system includes a printed circuit board (PCB). The PCB includes processing circuitry disposed on the PCB and configured to receive a control input, and to determine a motor control output based on the control input. A transformer disposed on the PCB is configured to receive input electrical power at a line voltage, and to generate electrical power at a step-down voltage using the input electrical power.

### CROSS REFERENCE TO RELATED APPLICATION

This application claims priority from and the benefit of U.S. Provisional Application Ser. No. 62/799,737, entitled “PRINTED CIRCUIT BOARD OF AN HVAC CONTROLLER,” filed Jan. 31, 2019, which is hereby incorporated by reference in its entirety for all purposes.

### BACKGROUND

A wide range of applications exists for heating, ventilation, and/or air conditioning (HVAC) systems. For example, residential, light commercial, commercial, and industrial systems are used to control temperatures and air quality in residences and buildings. Generally, HVAC systems may utilize a working fluid, such as a refrigerant or water, to heat and/or cool an airflow. For example, the HVAC system may circulate a refrigerant through a closed loop between an evaporator coil, where the fluid absorbs heat, and a condenser, where the fluid releases heat. The fluid flowing within the closed loop is generally formulated to undergo phase changes within the normal operating temperatures and pressures of the system, so that quantities of heat can be exchanged by virtue of the latent heat of vaporization of the fluid. Alternatively, a chiller may be used to supply cooled water, and/or a boiler may be used to supply heated water, where the temperature-controlled water is directed toward a heat exchanger. In either embodiment, a fan or fans may blow air over the heat exchanger(s) in order to condition the air.

In traditional embodiments, various discrete power and control components may be utilized to power and control various air flow components, such as a fan, a damper, a sensor, an electric heater, and the like. These discrete components may be expensive, and integration of the discrete components may involve complicated, discrete wiring. Further, utilizing discrete components may limit a functionality of the traditional control device.

The description above is intended to introduce the reader to various aspects of art that may be related to various aspects of the present disclosure, which are described below. The discussion in this section is believed to be helpful in providing the reader with background information to facilitate a better understanding of the various aspects of the present disclosure. Accordingly, it should be understood that these statements are to be read in this light, and not as admissions of prior art.

### SUMMARY

The present disclosure relates to a controller of a heating, ventilation, and/or air conditioning (HVAC) system having a printed circuit board (PCB). The PCB includes processing circuitry disposed on the PCB and configured to receive a control input, and to determine a motor control output based on the control input. A transformer disposed on the PCB is configured to receive input electrical power at a line voltage, and to generate electrical power at a step-down voltage using the input electrical power.

The present disclosure also relates to a controller of a heating, ventilation, and/or air conditioning (HVAC) system. The controller includes a printed circuit board (PCB). The controller also includes processing circuitry disposed on the PCB, configured to receive a first control input, configured to receive a second control input, and configured to determine a control output based on the first control input and the second control input. The controller also includes a transformer disposed on the PCB and configured to receive input electrical power at a line voltage and to generate electrical power at a step-down voltage using the input electrical power. The controller also includes a converter configured to receive the electrical power at the step-down voltage and to convert the electrical power at the step-down voltage to direct current voltage.

The present disclosure also relates to a controller of a heating, ventilation, and/or air conditioning (HVAC) system. The controller includes a printed circuit board (PCB). The controller also includes processing circuitry disposed on the PCB and configured to receive a remote input signal and to determine a control output based on the remote input signal. The PCB also includes a transformer disposed on the PCB and configured to receive input electrical power at a line voltage and to generate electrical power at a step-down voltage using the input electrical power.

### BRIEF DESCRIPTION OF THE DRAWINGS

FIG. 1 is a perspective view of a heating, ventilation, and air conditioning (HVAC) system for building environmental management, in accordance with an aspect of the present disclosure;

FIG. 2 is a schematic view of an HVAC controller for use in the HVAC system of FIG. 1, in accordance with an aspect of the present disclosure;

FIG. 3 is a schematic view of a printed circuit board of the HVAC controller of FIG. 2, in accordance with an aspect of the present disclosure;

FIG. 4 is a schematic view of a processor for use in the printed circuit board of FIG. 3, in accordance with an aspect of the present disclosure; and

FIG. 5 is a schematic view of a motherboard diagram of the printed circuit board of FIG. 3, in accordance with an aspect of the present disclosure.

### DETAILED DESCRIPTION

The present disclosure is directed generally toward heating, ventilation, and/or air conditioning (HVAC) systems, and more specifically to a printed circuit board of an HVAC controller.

Traditional HVAC systems may include several discrete power and control components utilized to power and control various air flow components, such as a fan, a damper, a sensor, and/or an electric heater of the HVAC system. These discrete components may be expensive, and integration of the discrete components may involve complicated, discrete wiring. Further, utilizing discrete components for power and control of the HVAC system may limit a functionality of the control device.

In accordance with the present disclosure, an HVAC controller configured to control a fan motor and other HVAC components may include a printed circuit board (PCB) having a processor and a transformer disposed on the PCB. The processor may be referred to as processing circuitry in certain portions of the disclosure below. The processor is configured to run control algorithms, such as logarithmic calculations and other basic logic, based on one or more control inputs received by the PCB. In some embodiments, the PCB may be configured to receive a remote signal, for example from a network-connected transceiver, as one of the control inputs. Further, at least one of the control inputs may be indicative of an operating parameter of a fan motor controlled by the HVAC controller, such as revolutions-per-minute (RPM) or torque output. The PCB may then output a control command signal to the fan motor, such as a 0-10V signal, a 2-10V signal, or a pulse width modulated (PWM) signal, which is indicative of a control command to the fan motor. That is, the 0-10V, 2-10V, or PWM signal, when received by the fan motor, may cause the fan motor to operate toward a particular operating parameter, such as a particular torque output or RPM associated with the control command.

The transformer of the PCB is configured to receive an input electrical power at a line voltage, and to generate electrical power at a step-down voltage using the input electrical power. For example, the on-board transformer may be configured to receive the input electrical power at the line voltage of 115 VAC, 208 VAC, 230 VAC, 277 VAC, and 480 VAC, such that the PCB and corresponding HVAC controller is configurable for receiving different line voltages. The on-board transformer may generate, from the input electrical power at the line voltage of 115 VAC, 208 VAC, 230 VAC, 277 VAC, or 480 VAC, electrical power having a step-down voltage of 24 VAC. A converter may also be disposed on the PCB, and may convert the electrical power at the step-down voltage of 24 VAC to 24 VDC. The 24 VDC may be output to external HVAC devices, such as a fan motor, a damper, a sensor, an electric heater, relays, or actuators, and/or may be used to power on-board fan relays and microprocessors. In certain embodiments, other output voltages may also be possible, such as 16 VDC, 5 VDC, 3.3 VDC, and others.

By including the above-described processor and the above-described transformer on the PCB, an overall cost of the HVAC controller may be reduced relative to traditional embodiments having discrete wiring between discrete components. Further, an installation and set-up process may be simplified compared to traditional embodiments that include discrete components and corresponding discrete wiring. Further still, the HVAC controller may include improved functionality over traditional embodiments, which may be limited by component selections intended to reduce the above-described cost burdens associated with traditional embodiments. These and other features will be described in detail below with reference to the drawings.

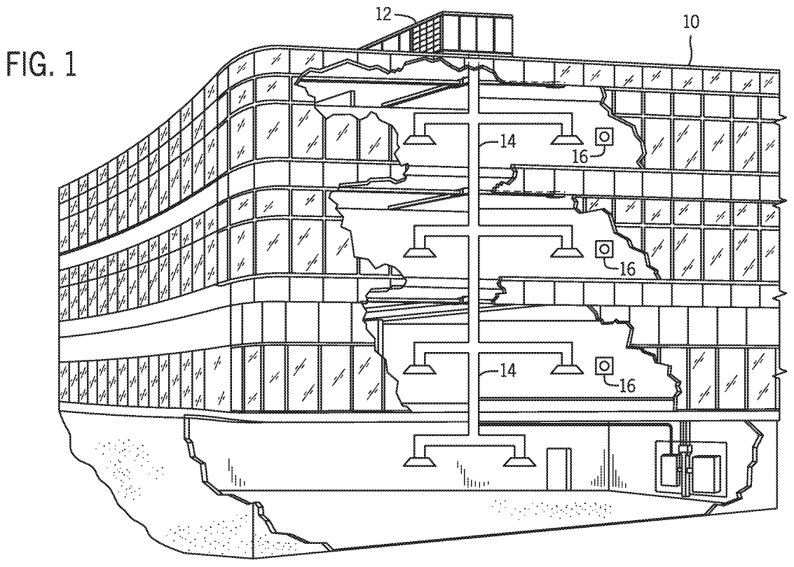

Turning now to the drawings, FIG. 1 illustrates an embodiment of a heating, ventilation, and/or air conditioning (HVAC) system for environmental management that may employ one or more HVAC units. As used herein, an HVAC system includes any number of components configured to enable regulation of parameters related to climate characteristics, such as temperature, humidity, air flow, pressure, air quality, and so forth. For example, an “HVAC system” as used herein is defined as conventionally understood and as further described herein. Components or parts of an “HVAC system” may include, but are not limited to, all, some of, or individual parts such as a heat exchanger, a heater, an air flow control device, such as a fan, a sensor configured to detect a climate characteristic or operating parameter, a filter, a control device configured to regulate operation of an HVAC system component, a component configured to enable regulation of climate characteristics, or a combination thereof. An “HVAC system” is a system configured to provide such functions as heating, cooling, ventilation, dehumidification, pressurization, refrigeration, filtration, or any combination thereof. The embodiments described herein may be utilized in a variety of applications to control climate characteristics, such as residential, commercial, industrial, transportation, or other applications where climate control is desired.

In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

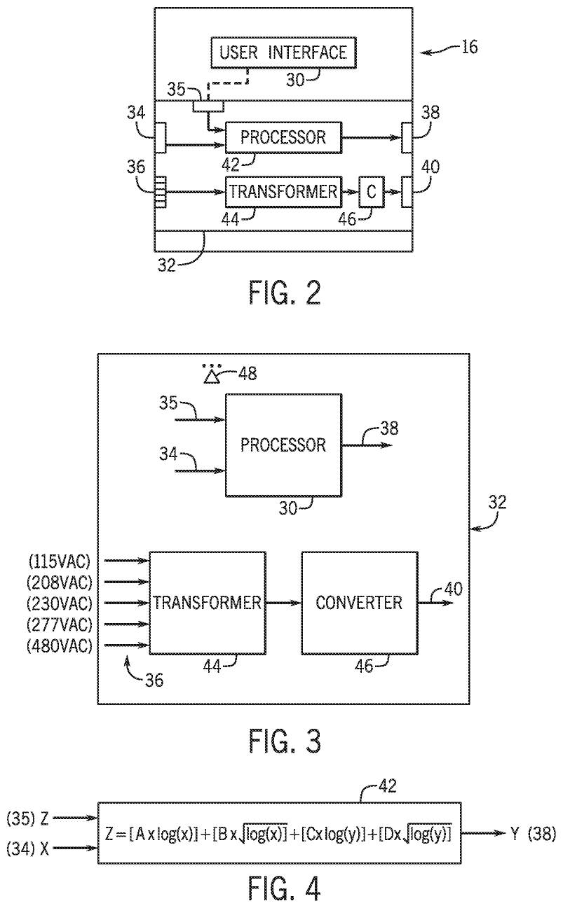

In accordance with present embodiments, the control device 16, which may be referred to as an HVAC controller with respect to FIGS. 2-6 below, may include a printed circuit board (PCB) having a processor and a transformer disposed on the PCB. The processor, which may be referred to as processing circuitry in certain portions of the disclosure below, is configured to run control algorithms, such as logarithmic calculations and other basic logic, based on one or more inputs received by the PCB. In some embodiments, the PCB may be configured to receive a remote signal as one of the control inputs. Further, at least one of the control inputs may be indicative of a detected operating parameter of a fan motor controlled by the HVAC controller, such as revolutions-per-minute (RPM) or torque output. The processor of the PCB may be configured to determine and output a fan motor control command based on an algorithm, such as a logarithmic algorithm, receiving the fan motor input and/or other potential inputs.

The transformer of the PCB is configured to receive an input electrical power at a line voltage, and to generate electrical power at a step-down voltage using the input electrical power. The transformer may be configured to receive a number of different line voltages, such that the HVAC controller is configurable for various applications. A converter may also be disposed on the PCB, and may convert the step-down voltage from VAC to VDC, such that the VDC may be output to drive external HVAC devices, such as a fan motor, a damper, a sensor, an electric heater, or others. By including the processor and the transformer on the PCB of the HVAC controller 16, a cost of the HVAC controller 16 is reduced over traditional embodiments, versatility of the HVAC controller 16 is improved, and complicated, discrete wiring techniques are reduced or negated compared to traditional embodiments.

FIG. 2 is a schematic view of an embodiment of the HVAC controller 16, for use in the HVAC system of FIG. 1. In the illustrated embodiment, the HVAC controller 16 includes a user interface 30 and a printed circuit board (PCB) 32. The user interface 30 may include, for example, push buttons, a graphical user interface (GUI), or the like configured to receive user inputs. Certain user inputs entered to the user interface 30 may be received by the PCB 32 for processing.

As shown, the PCB 32 may include control input ports 34, 35, or terminals, configured to receive control signals. The control input port 34 may receive a control signal from an external device, and the control input port 35 may receive a control signal from the user interface 30. Alternatively, the control input port 35 may receive a control signal from a source other than the user interface 30, such as a building management signal. The control signals received at the control input ports 34, 35 may then be communicated to a processor 42 disposed on the PCB 32. Other input ports may also be included on the PCB 32, and control signals received therefrom may be communicated to the processor 42. It should be noted that either of the control signals received from the control input ports 34, 35, and/or another control signal, may be a remote signal. That is, the PCB 32 may include network connectivity for remote communication, such that the PCB 32 of the HVAC controller 16 is configurable for receiving remote signals. Additionally or alternatively, the PCB 32 may be connected to an external transceiver having network connectivity, which communicates the remote signal to the PCB 32 via a wire connection.

The processor 42 of the PCB 32 may run control algorithms, such as a logarithmic control algorithm and/or other basic logic, to determine a control command based on one or more control signals received at the processor 42. For example, one of the control inputs may correspond to a detected operating parameter of the HVAC system, such as a detected torque output or detected RPM of a fan motor, and another of the control inputs may correspond to a target performance parameter of the HVAC system, such as a target temperature or power consumption. In some embodiments, the target performance parameter may be received via a remote signal, as described above. The processor 42 may then compute, based on the received control inputs, a control command. For example, the processor 42 may compute, based on a logarithmic algorithm that receives at least one of the control inputs, a target RPM or target torque output of the fan motor. The processor 42 may output a control signal indicative of the control command via a control signal output port 38, or terminal. In some embodiments, the PCB 32 may include other control signal output ports, or terminals, and may be capable of outputting control signals to other devices, such as a damper, a sensor, an electric heater, etc. In the illustrated embodiment, the processor 42 may output a 0-10V signal, a 0-20V signal, or a pulse width modulated (PWM) signal via the control signal output port 38, whereby the 0-10V signal, the 0-20V signal, or the PWM signal is indicative of the computed control command and is be interpretable by the device, such as the fan motor or a variable-speed drive (VSD), receiving the control command.

Additionally, the PCB 32 includes a line voltage power input 36, which may be referred to as a line-in terminal. A transformer 44 disposed on the PCB 32 may be configured to receive an input electrical power at a line voltage from the line-in terminal 36. In the illustrated embodiment, the line-in terminal 36 is configured to receive the input electrical power at the line voltage of 115 VAC, 208 VAC, 230 VAC, 277 VAC, and 480 VAC. That is, the PCB 32 is configured to receive any one of the line voltages of 115 VAC, 208 VAC, 230 VAC, 277 VAC, and 480 VAC. The transformer 44 is configured to generate, from the input electrical power at the line voltage of 115 VAC, 208 VAC, 230 VAC, 277 VAC, or 480 VAC, an electrical power at a step-down voltage of, for example, 24 VAC. In some embodiments, as shown, the PCB 32 also includes a converter 46 configured to receive the step-down voltage, for example the step-down voltage of 24 VAC, and convert it to 24 VDC. The 24 VDC power can be output, via a power output port 40, to external devices, such as a fan motor, a damper, a sensor, etc. Other output voltages may also be possible, such as 16 VDC, 5 VDC, 3.3 VDC, and others. FIG. 3 is a schematic view of an embodiment of the PCB 32 of the HVAC controller 16 of FIG. 2, having the various inputs and outputs described above. As shown, the line-in terminal 36 or ports can receive 115 VAC, 208 VAC, 230 VAC, 277 VAC, and 480 VAC. Communications circuitry 48, such as a network-connected transceiver, is illustrated in the PCB 32 of FIG. 3, and may enable the processor 30 of the PCB 32 to receive a remote signal. In other embodiments, the PCB 32 may be wired to an external device that receives the remote signal. For example, in certain embodiments, one or more of the control input ports 34, 35 in FIG. 3 may receive a remote signal, directly or indirectly, from a remote component or system, such as a building management system. The remote signal may be indicative of a target performance parameter or other control input of the HVAC system, including one or more of a constant airflow target of a fan motor, a constant power consumption target of the fan motor, a constant sound output target of the fan motor, or others. In certain embodiments, the target performance parameter(s) may include target threshold values between which the HVAC controller and corresponding PCB 32 control the fan motor. Aspects of the control algorithm(s) ran by the processor 30 of the PCB 32 will be described in detail below.

FIG. 4 is a schematic view of an embodiment of the processing circuitry 42 for use in the PCB 32 of FIG. 3. FIG. 4 illustrates one control algorithm, a logarithmic control algorithm, although other control algorithms may be additional or alternatively employed by the processing circuitry 42.

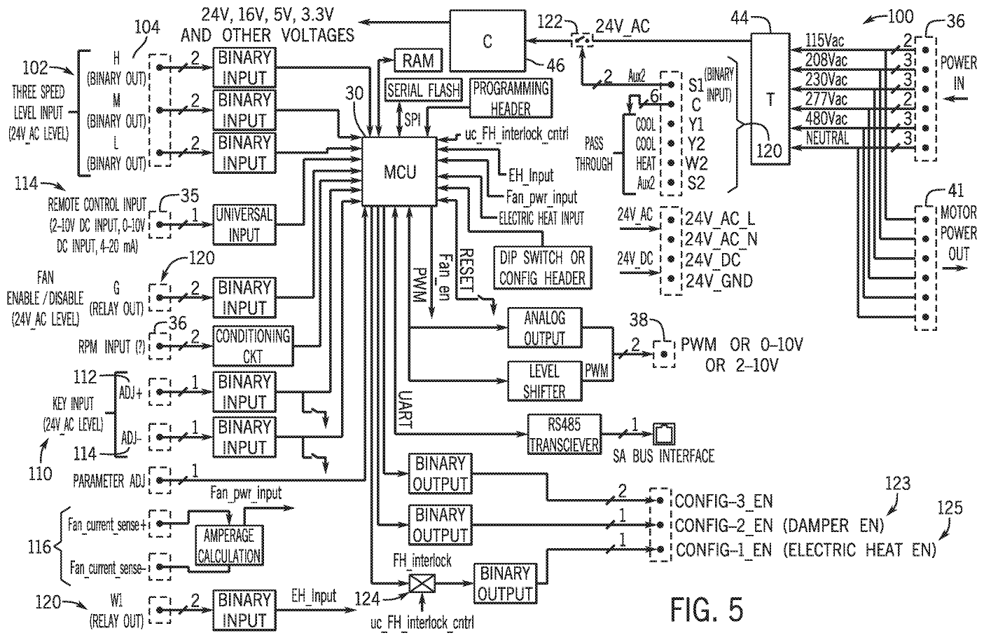

As described above, the processing circuitry 42 may be configured to receive any number of control inputs. In the illustrated embodiment, the processing circuitry 42 is configured to receive a first control input, X, for example from the control input port 34. The processing circuitry 42 is also configured to receive a second control input, Z, for example from the control input port 35. As previously described, at least one of the control inputs X, Z may be received as a remote signal. As will be shown, and described with respect to, FIG. 5, the processing circuitry 42 may be configured to receive a number of other inputs. The illustration of FIG. 4, and corresponding description, is intended to provide an example of one fan motor control algorithm which the processing circuitry 42 is capable of computing.

The processing circuitry 42 may utilize a fan control algorithm or model to calculate a torque output target value of a fan motor corresponding to an operating mode target value and detected RPM, where the operating mode target value is, for example, a constant airflow mode target value, a constant power consumption mode target value, or a constant sound output mode target value. In accordance with the present disclosure, the fan control algorithm or model is as follows:

Z=A*log(X)+B*\sqrt{log(X)}+C*log(Y)+D*\sqrt{log(Y)}, Equation 1-

where Z=the operating mode target value (e.g., received as a control input at the control input port 35), X=a detected operating parameter (e.g., received as a control input at the control input port 34), Y=a calculated target parameter (e.g., a torque output target, or parameter indicative thereof), and A, B, C, and D are coefficients dependent on fan design and the selection of Z (e.g., selection between constant airflow mode, constant power mode, constant sound output mode, etc.). That is, the processing circuitry 42 may receive Z and X as inputs, and may determine Y based on Equation 1.

It should be noted that Equation 1 may be applied for a constant torque motor whereby X=a detected RPM and Y=a calculated torque output target, but that Equation 1 may also be applied in another context for a constant RPM motor whereby X=a detected torque output and Y=a calculated torque output target. Descriptions below may emphasize embodiments having the constant torque motor (e.g., where X=a detected RPM value and Y=a calculated torque output target value, or parameter indicative thereof) for purposes of clarity, but it should be understood that the same or similar concept applies to a constant RPM motor (e.g., where X=a detected torque output value, or parameter indicative thereof, and Y=a calculated RPM value).

Further, Equation 1 is applicable to each of the fan motor operating modes contemplated by the present disclosure. That is, Equation 1 is applicable to all of the operating modes contemplated by the present disclosure, including but not limited to embodiments where Z may be equal to the constant airflow mode target value, constant power consumption mode target value, constant sound output mode target value, or some other operating mode target value such as total or external static pressure. In some embodiments, an intercept constant (E) may be added to the right side of Equation 1 to improve operation. As noted above, coefficients A, B, C, and D are different for each selection of Z and are dependent on fan design. That is, each operating mode includes a difference set of coefficients A, B, C, and D, which are dependent in part on the selection of operating mode target value Z, for example selecting Z=a constant airflow mode target value, Z=a constant sound output mode target value, or Z=a constant power consumption mode target value. The coefficients A, B, C, and D may be developed during a baselining or testing procedure in which the fan is installed and tested in the HVAC system, as previously described. As previously described, actual operating RPM may be detected by a speed sensor associated with the fan or fan motor, and the processing circuitry 42 may receive a control input signal, for example via input terminal 34, indicative of RPM from the speed sensor or an intervening component.

The fan control algorithm of Equation 1 may be employed via an iterative process which controls the fan motor 104 toward a torque output and RPM suitable for the constant operating mode target value. For example, the processing circuitry 42 may receive the operating mode target value at input terminal 35, and input the operating mode target value as Z in Equation 1. The processing circuitry 42 may also receive the RPM data from the speed sensor at input terminal 34, and input the RPM as X in Equation 1. The processing circuitry 42 may then solve the fan control algorithm in Equation 1 for Y, which is torque or a parameter indicative of torque. The processing circuitry may then control the fan motor toward or at the calculated torque output target value, by outputting a control command via output terminal 38. As the processing circuitry 42 controls the fan motor to change the torque output, the RPM may change. Thus, the processing circuitry 42 may again enter the operating mode target value, received at input terminal 35, as Z in Equation 1, may enter the newly detected RPM, received at input terminal 34, as X in Equation 1, and may solve for Y. The processing circuitry 42 may then control the fan motor toward or at the newly detected Y, via a control command sent to the fan motor, in the form of a 0-10V, 2-10V, or PWM signal, through output terminal 38. This process may be repeated until the calculated torque output target value is substantially equal to the operating torque output, which indicates that the motor 104 is being controlled at an RPM and torque output which causes the HVAC system 100 to substantially reach or substantially achieve the operating mode target value during normal operation. As previously described, in some embodiments, such as embodiments employing a constant RPM motor, the fan control algorithm may receive a detected torque output as X in Equation 1, and may solve for a RPM target value as Y. In these embodiments, a load sensor 123 may be employed to detect the torque output.

It should also be noted that FIG. 4 is illustrative of one control algorithm and corresponding inputs received by the processing circuitry 42. Indeed, the disclosed PCB having the processor 42 disposed thereon may receive other inputs, such as motor inputs indicating whether the motor is operating a low, medium, or high speed in a 3-speed motor embodiment, a fan enable/disable input indicating whether a fan is operating, fan current sense inputs, fan adjust inputs (e.g., at a 24 VAC level), etc.

FIG. 5 is a schematic view of an embodiment of a motherboard diagram 100 to be included on the PCB of FIG. 3. It should be noted that the illustrated motherboard diagram 100 is one embodiment that may be employed via the PCB, but that other structures are also possible. In the illustrated embodiment, the motherboard diagram 100 includes the transformer 44, which is configured to receive input electrical power at the line voltage via the line-in terminal 36. As previously described, the input electrical power may be received, via the line-in terminal 36, at the line voltage of 115 VAC, 208 VAC, 230 VAC, 277 VAC, and 480 VAC. The transformer 44 may generate, from the input electrical power at the line voltage, an electrical power having a step-down voltage, for example having a step-down voltage of 24 VAC. The converter 46 may receive the electrical power having the step-down voltage and convert it to direct current, for example 24 VDC. However, as shown, other voltages are also possible, such as 16 VDC, 5 VDC, or 3.3 VDC. The input electrical power at the line voltage may also be output via power output terminal 41, as shown. As previously described, including the transformer 44 on the PCB may reduce complicated wiring techniques associated with having a discrete transformer 44 off-board, a total cost may be reduced, and functionality of the PCB and corresponding HVAC system may be improved.

The motherboard diagram 100 also includes the processor 30, which may be powered by an appropriate voltage that is stepped-down and/or converted by the transformer 44 and/or the converter 46, respectively. The processor 30, depending on the configuration, may receive one or more of several possible inputs shown in the illustrated embodiment. For example, the processor 30 may receive a remote control input via the control input terminal 35. The remote control input signal may be received from an external transceiver wired to the PCB, or from a transceiver disposed on the PCB. The remote control input signal may correspond to a building management signal, and/or may be in the form of a 2-10V signal, 0-10V signal, or 4-20 mA signal. As previously described, the processor 30 may receive an input from a fan motor, such as via input terminal 34, indicative of an RPM of the fan motor, or a torque output of the fan motor. The processor 30 may utilize the inputs received at input terminals 34, 35 to calculate a fan motor control command, as described above with respect to FIG. 4. The fan motor control command may be output from the processor 30 via, for example, output terminal 38. However, other outputs based on the above-described inputs, or based on additional or alternative inputs, may also be possible, as described below.

As shown, the motherboard diagram 100 of the PCB may include several other control input terminals capable of receiving inputs based on various system-specific configurations. The PCB may then determine a control output based on the received inputs. The form and function of the output may be based on the configuration of the PCB. For example, if the board is configured for three speed operation, it will receive a 24V signal 102 for either Hi 104, Medium 106 or Low 108. The output signal sent to the motor will be via output terminal 38 in the form of a 0-10 VDC, 2-10 VDC, or PWM signal.

If the board is configured for single speed with manual balancing, the input signal may be a 24 VAC signal 110 for either adjust up 112 or adjust down 124, and the control output signal sent to the motor will be variable based on user input via board level components. If the board is configured for a remote signal or a BMS (e.g., input terminal 35), it will receive a 0-10V, 2-10V or 4-20 mA signal 114 and scale the 0-10 VDC, 2-10 VDC, or PWM signal to the motor output, output from output terminal 38, accordingly. The board will receive a feedback signal from either one or two motors monitoring the real time RPM (e.g., at input terminal 36) of the motors. The microprocessor will enable the execution of algorithms controlling the motors output based on the input for the speed, and the monitoring of either the amp draw (e.g., at inputs 116) or RPM of the motor. Other control outputs may include a damper control output 123 and an electric heater control output 125 (e.g., on or off).

Various thermostat terminal inputs may be received based on a connection configuration for a particular HVAC context, for example a fan coil unit (FCU) or blower coil unit (BCU) usage. For example, the thermostat connections 24 VAC (R), C, G, Y1, Y2, W1, W2, S1 and S2, labeled 120, are available for customer connection via screw terminal or by factory connection. An R signal, or fan enable signal, is the line side of the start/stop functionality and the illustrated G signal is the load side of the start/stop functionality. Between the S1 and C terminals, a condensate drain pan float switch 122 can be added to remove 24 VAC from the assembly to stop the fan and to close the water valve before the drain pan overflows. Signals Y1 and Y2 are terminal points for chilled water valve actuator connections and do not have any internal traces on the assembly. Signals W1 and W2 are terminal points for hot water valve actuator connections. The W1 input is internally connected to the electric heat output through a fan-EH interlock 124. W2 does not have any internal traces on the assembly. S2 is an auxiliary terminal connection that does not have any internal traces on the assembly.

The various thermostat terminal inputs may also be utilized for variable air volume usage. For example, the controller connections 24 VAC (R), G, Y1, Y2, W1, W2, S1 and S2 are available for the customer connection via screw terminal or by factory connection. An R signal, or fan enable signal, is the line side of the start/stop functionality and the illustrated G signal is the load side of the start/stop functionality. Signals Y1, Y2, W2 and S2 are used for controller connections from the VAV controller to ancillary components and do not have any internal traces on the assembly. The W1 signal is used for electric heat. The W1 input is internally connected to the electric heat output through a fan-EH interlock.

When controlled by a thermostat/controller, this assembly will receive signals remotely, monitor motor outputs, energize a particular fan relay and actuate water valves or electric heat relays in unpredictable sequences and frequencies. It will be able to algorithmically control the motor output based on these signals. The purpose of this assembly is to receive these signals and relay them to the appropriate components in a safe, reliable manner.

In accordance with the present disclosure, by including the above-described processor and the above-described transformer on the PCB, an overall cost of the HVAC controller may be reduced relative to traditional embodiments having discrete wiring between discrete components. Further, an installation and set-up process may be simplified compared to traditional embodiments that include discrete components and corresponding discrete wiring. Further still, the HVAC controller may include improved functionality over traditional embodiments, which may be limited by component selections intended to reduce the above-described cost burdens associated with traditional embodiments. These

While only certain features and embodiments of the disclosure have been illustrated and described, many modifications and changes may occur to those skilled in the art, such as variations in sizes, dimensions, structures, shapes and proportions of the various elements, values of parameters including temperatures and pressures, mounting arrangements, use of materials, colors, orientations, etc., without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the exemplary embodiments, all features of an actual implementation may not have been described, such as those unrelated to the presently contemplated best mode of carrying out the disclosure, or those unrelated to enabling the claimed disclosure. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A controller of a heating, ventilation, and/or air conditioning (HVAC) system, comprising:
a printed circuit board (PCB);
processing circuitry disposed on the PCB and configured to receive a control input and to determine a motor control output based on the control input; and
a transformer disposed on the PCB and configured to receive input electrical power at a line voltage and to generate electrical power at a step-down voltage using the input electrical power.

2. The controller of claim 1, comprising a converter disposed on the PCB and configured to convert the electrical power at the step-down voltage to a direct current (DC) voltage, and to output the DC voltage to power the processing circuitry.

3. The controller of claim 2, wherein the converter is configured to output the DC voltage to power on-board fan relays.

4. The controller of claim 2, wherein the converter is configured to output the DC voltage to power a damper of the HVAC system, an electric heater of the HVACY system, or both.

5. The controller of claim 2, wherein the converter is configured to convert the electrical power at the step-down voltage of 24 VAC to the DC voltage of 24 VDC.

6. The controller of claim 1, wherein the control input is indicative of a fan motor operating parameter received from a fan motor or sensor of the fan motor.

7. The controller of claim 1, wherein the motor control output is indicative of a fan motor target operating parameter.

8. The controller of claim 1, wherein the processing circuitry is configured to receive the control input and to determine the motor control output based on the control input and a logarithmic control algorithm.

9. The controller of claim 1, wherein:
the control input is indicative of a detected rotations per minute (RPM) or a detected torque of a fan motor; and
the motor control output is indicative of a target RPM or a target torque of the fan motor.

10. The controller of claim 1, wherein the control input includes a thermostat input received from a thermostat.

11. The controller of claim 1, wherein the control input includes a remote signal.

12. The controller of claim 1, wherein the motor control output includes a 0-10V signal, a 2-10V output, or a PWM output.

13. The controller of claim 1, wherein the transformer is configured to receive the input electrical power at the line voltage of 115 VAC, 208 VAC, 230 VAC, 277 VAC, and 480 VAC.

14. A controller of a heating, ventilation, and/or air conditioning (HVAC) system, comprising:
a printed circuit board (PCB);
processing circuitry disposed on the PCB, configured to receive a first control input, configured to receive a second control input, and configured to determine a control output based on the first control input and the second control input;
a transformer disposed on the PCB and configured to receive input electrical power at a line voltage and to generate electrical power at a step-down voltage using the input electrical power; and
a converter configured to receive the electrical power at the step-down voltage and to convert the electrical power at the step-down voltage to direct current voltage, and wherein the converter is configured to output the direct current voltage to the processing circuitry to power the processing circuitry.

15. The controller of claim 14, wherein the transformer is configured to receive the input electrical power at the line voltage of 115 VAC, 208 VAC, 230 VAC, 277 VAC, and 480 VAC.

16. The controller of claim 14, wherein the processing circuitry is configured to receive the first control input as a remote signal.

17. The controller of claim 14, wherein the control output includes a 0-10V signal, a 2-10V output, or a PWM output.

18. A controller of a heating, ventilation, and/or air conditioning (HVAC) system, comprising:
a printed circuit board (PCB);
processing circuitry disposed on the PCB and configured to receive a remote input signal and to determine a control output based on the remote input signal; and
a transformer disposed on the PCB and configured to receive input electrical power at a line voltage and to generate electrical power at a step-down voltage using the input electrical power.

19. The controller of claim 18, comprising a converter configured to receive the electrical power at the step-down voltage and to convert the electrical power at the step-down voltage to direct current voltage, and wherein the converter is configured to output the direct current voltage to the processing circuitry to power the processing circuitry.

20. The controller of claim 19, wherein the converter is configured to convert the electrical power at the step-down voltage of 24 VAC to the DC voltage of 24 VDC.

21. The controller of claim 18, wherein the transformer is configured to receive the input electrical power at the line voltage of 115 VAC, 208 VAC, 230 VAC, 277 VAC, and 480 VAC.

22. The controller of claim 18, wherein the control output includes a 0-10V signal, a 2-10V output, or a PWM output.

23. The controller of claim 18, wherein the remote input signal corresponds to a building management system input.
